(19) United States
(12) Patent Application Publication
(10) Pub. No.: US 2026/0131281 A1
(43) Pub. Date: May 14, 2026

(54) MOBILE DEHUMIDIFIER WATER SUPPLY SYSTEM

(71) Applicants: David Christ, Staunton, VA (US); Lynette Christ, Staunton, VA (US)

(72) Inventors: David Christ, Staunton, VA (US); Lynette Christ, Staunton, VA (US)

(21) Appl. No.: 18/944,447

(22) Filed: Nov. 12, 2024

(51) Int. Cl. B01D 53/26; E03B 3/28

(52) U.S. Cl. CPC B01D 53/265; E03B 3/28; B01D 2257/80; B01D 2258/06; B01D 2259/4558

(57) ABSTRACT

The disclosure is a mobile dehumidifier water supply system including an insulated housing comprising a dehumidifier, a condensed water storage, and a water filter for a condensed water flow there between. The disclosure also includes two wheels set on a width and a length of the insulated housing to carry the insulated housing thereon. The disclosure additionally includes a solar panel hinged to the insulated housing and configured to rotate on the hinge to minimize an angle of incidence of a light striking the solar panel. The disclosure further includes a monitor control module configured to electrically monitor and control the water supply system.

### SUMMARY OF THE INVENTION

The disclosure is a mobile dehumidifier water supply system including an insulated housing comprising a dehumidifier, a condensed water storage, and a water filter for a condensed water flow there between. The disclosure also includes two wheels set on a width and a length of the insulated housing to carry the insulated housing thereon. The disclosure additionally includes a solar panel hinged to the insulated housing and configured to rotate on the hinge to minimize an angle of incidence of a light striking the solar panel. The disclosure further includes a monitor control module configured to electrically monitor and control the water supply system.

### BRIEF DESCRIPTION OF THE DRAWINGS

FIG. 1 is a side perspective view of the mobile dehumidifier water supply system in accordance with an embodiment of the present disclosure.

FIG. 2 is a side perspective view of an additional trifold solar panel for the mobile dehumidifier water supply system in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

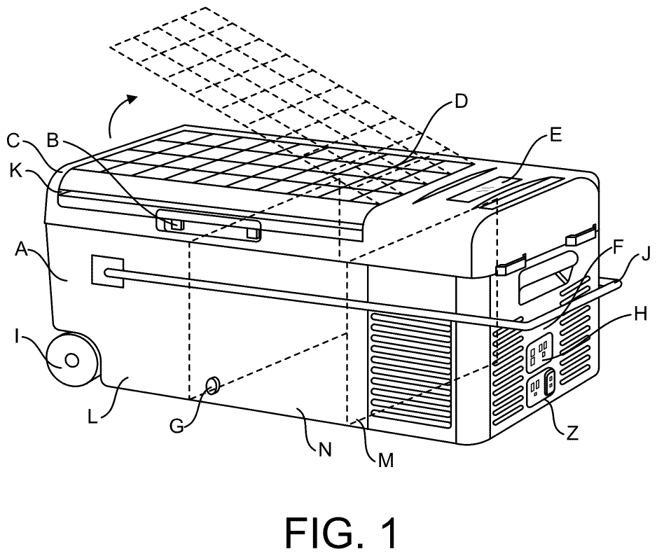

FIG. 1 is a side perspective view of the mobile dehumidifier water supply system in accordance with an embodiment of the present disclosure. The disclosure is an off the grid water source conceived for the safety/environmental commercial industry. The disclosure consists of the following separate items listed below: Water tank A, Latch B, Hinged lid C, Solar panel D, Display panel (humidity level, water temperature, water level, power level) E, Dehumidifier and condensed water filtration F, condensed water spout and plug G, electrical panel H, wheels I, retractable handle J, slot to store trifold solar panel when not in use K, solar power battery and electrical generator unit L, condensed water storage M and filtered and temperature controlled water storage N and electrical outlet Z for a parallel hookup of multiple mobile dehumidifier water storage systems.

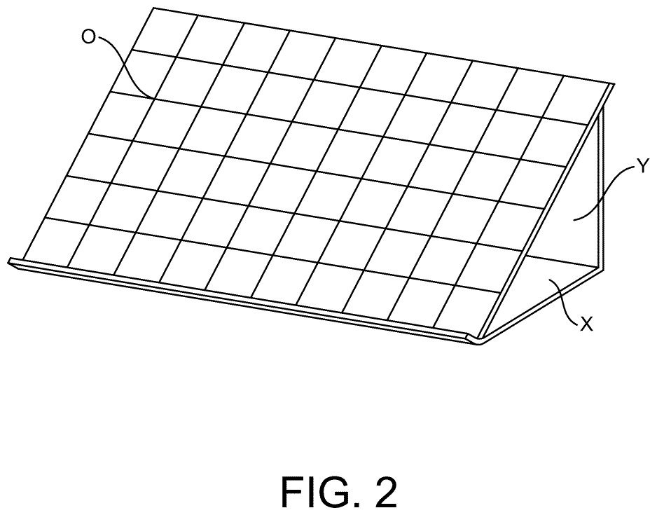

FIG. 2 is a side perspective view of an additional trifold solar panel for the mobile dehumidifier water supply system in accordance with an embodiment of the present disclosure. The trifold solar panel includes a hypotenuse side including solar cells arranged in a panel supported by right triangle sides x and y.

The disclosure provides a sustainable and reliable means to ensure safe drinking water in environments where traditional water sources are limited or contaminated. In many regions, especially in warm and humid climates or off-grid areas, access to safe drinking water is often limited or the traditional water sources a community relies on may be contaminated with pollutants or pathogens, posing serious health risks.

Presently, conventional methods of water purification utilize electricity from non-renewable sources for power; thus, contributing to carbon emissions and environmental degradation which tends to be at the root of such a problem. Ingenious and practical, the disclosure introduces a comprehensive and sustainable solution to the challenge of accessing clean drinking water in various environments that, by its design, is focused on reducing environmental impact.

With the ability to generate safe drinking water from the air, the disclosure harnesses solar power to operate a commercial dehumidifier and water filtration system whereas the unit effectively extracts moisture from the air, purifies it, and stores it for consumption, at a later time. Comprised of quality materials and employing a digital panel for personal monitoring of the collected water temperature and water levels within the primary tank, in addition to, tracking the unit's present battery power level and air humidity level, the disclosure serves to mitigate the pressing challenges of water scarcity and contamination by providing a versatile and eco-friendly solution for generating safe drinking water in various contexts.

Furthermore, farmers in remote or arid areas may struggle to provide adequate water for their livestock, impacting animal health and productivity; thus, Off the Grid Water Source allows an animal caretaker to utilize a convenient accessory for supplying clean water to livestock, improving their welfare and overall farm productivity. By combining the benefits of a dehumidifier and filtration system into a single water unit accessory capable of producing water free from impurities, the disclosure revolutionizes independent water accessibility and thus may prove to be essential in the safety/environmental commercial industry.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A water supply system comprising:
an insulated housing comprising a dehumidifier, a condensed water storage, and a water filter for a condensed water flow there between;
at least two wheels set on a width and a length of the insulated housing and configured to carry the insulated housing thereon;
a solar panel hinged to the insulated housing and configured to rotate on the hinge to minimize an angle of incidence of a light striking the solar panel;
a monitor control module configured to electrically monitor and control the water supply system.

2. The water supply system of claim 1, further comprising an on-board electric generator and a power inlet for an external generator.

3. The water supply system of claim 1, wherein the trailer further comprises a hitch and ball configured to hitch a plurality of water supply systems connected in series.

4. The water supply system of claim 1, wherein the monitor control module further comprises an environmental humidity monitor and control electronics.

5. The water supply system of claim 1, wherein the monitor control module further comprises an electronics to monitor and control an amount and temperature of the water flow.

6. The water supply system of claim 1, wherein the monitor control module further comprises an electronics to monitor and control a battery power level.

7. The water supply system of claim 1, wherein the monitor control module further comprises an electronics to monitor and control an on-board power generator.

8. The water supply system of claim 1, further comprising a locking latch for the solar panel.

9. The water supply system of claim 1, further comprising a retractable handle for the system and disposed on the insulated housing.

10. The water supply system of claim 1, further comprising an additional tri-fold solar panel configured to store adjacent the insulated housing.

11. The water supply system of claim 10, wherein the additional tri-fold solar panel includes a hypotenuse side having solar panels and a right triangle support.

12. The water supply system of claim 1, further comprising a retractable handle configured to rotate and support the solar panel on the hinge.

13. The water supply system of claim 1, further comprising a spout and complementary plug configured to drain the condensed water flow.

14. The water supply system of claim 1, wherein the control monitor further comprises a touch screen display panel for input and output.

15. The water supply system of claim 1, wherein the insulated housing comprises an electrical power inlet and outlet configured to connect multiple water supply systems electrically in parallel.
